(19) United States
(12) Patent Application Publication
(10) Pub. No.: US 2016/0333290 A1
(43) Pub. Date: Nov. 17, 2016

(54) Continuous In-Line Process for Making Fragrance Composition

(71) Applicant: The Procter & Gamble Company, Cincinnati, OH (US)

(72) Inventors: Sarah Noelle ABSHER, Cincinnati, OH (US); William James WHITTAKER, Addlestone (GB); Anna Frances GALLOWAY, Killingworth (GB); Wundriari Hagnyono Arif HOFFMANN, Camberley (GB)

(21) Appl. No.: 15/148,012

(22) Filed: May 6, 2016

Related U.S. Application Data
(60) Provisional application No. 62/160,608, filed on May 13, 2015.

(51) Int. Cl. C11B 9/00

(52) U.S. Cl. CPC C11B 9/00

(57) ABSTRACT

A continuous in-line process of making fragrance composition by the ratio addition of solvents pre- and post- the filtering step to accelerate wax precipitation formed from waxy carry-overs from the perfume raw materials.

### FIELD OF THE INVENTION

The present invention relates to methods of making fragrance composition on a commercial scale, specifically, continuous manufacturing methods involving a chemical solubility mechanism for accelerating precipitation transformation.

### BACKGROUND OF THE INVENTION

A fragrance composition, such as perfume, is typically made in a batch making process using vessels, such as a batch mixing tank, equipped with a standard agitator or high shear mixing device. With reference to FIG. 1 detailing the classic batch manufacturing approach, as a first step, solvents (e.g., ethanol, water) and non-polar ingredients (e.g., perfume oils) are usually added to the mixing tank, per a defined recipe. As the next step, adjunct ingredients (e.g., UV stabilizers, non-perfume oil mixtures, etc.), if present, are added directly to the mixing tank, or alternatively to a slurry tank first then added to the mixing tank (not shown). The perfume oils, used to make fragrance composition, contain high levels of natural ingredients that contain waxy carry-overs which are soluble in the perfume oils. However, mixing non-polar perfume oils with the ethanol-water solvent system causes the waxes to precipitate out of solution. Precipitation in the final product is viewed as a consumer negative and needs to be completely removed from the product before packaging. As a result, a lengthy residence time (e.g., from 15 mins to 1.5 hours) and/or chilling step is critical with the classic batch making process to allow for sufficient mixing in order for complete formation of the precipitated waxes. The product is chilled from ambient temperature to about 0° C. and then filtered to remove the undesirable wax precipitates formed during the batch making process. Furthermore, after filtering, an optional step of adding other non-polar ingredients to the finished product, such as for example, dyes for aesthetic purposes, is desirable. It is not possible to add the dyes in advance of the filtering step because the non-polar dyes would also fall out of solution like the perfume oils during chilling and be removed in the filtering step. This additional step adds complexity to the batch making process.

There are at least several drawbacks to the above described batch process. Firstly, the typical batch making process is time-consuming and can take about 4-6 hours to produce about 1.5 tons of product. The bulk of the batch cycle is attributable to the residence time needed for mixing and chilling to precipitate the wax from solution. In addition, a “maceration” time of between 15 mins to 90 mins is also required with the batch making process in order to allow for the final product to achieve the desired olfactory profile. These events can account for up to 60% of the total processing time with the batch making method. Secondly, the batch making system is inflexible by design. For example, the mixing tank size dictates the batch size. As a result, bulk production runs will tend to overproduce versus demand and additional costs are incurred to store the excess inventory before the product can be packaged and sold. Lastly, the batch making process requires the time-consuming and energy intensive chilling step in order to allow for removal of the undesirable non-polar ingredients (e.g., waxy precipitates from the perfume oils) before the addition of the desirable non-polar ingredients (e.g., dyes). Therefore, there remains a need for a fragrance composition making methodology that is capable of producing-to-demand amounts of product to minimize waste, cost, and/or time.

It is an advantage of the invention to have comparable quality of end product (e.g., odor profile, visual appearance) as current batch making processes. It is a further advantage to have increase rate of production on a weight basis. It is a further advantage to minimize capital costs. It is a further advantage to reduce the manufacturing area footprint at the manufacturing site. It is a further advantage to minimize energy costs (e.g., refrigeration). It is a further advantage to minimize inventory of end products as well as raw materials. It is a further advantage to minimize time and materials associated with frequent changeovers (i.e., changing the formula of the fragrance composition). It is a further advantage to remove undesirable non-polar ingredients but also add desirable non-polar ingredients without requiring a chilling step.

### SUMMARY OF THE INVENTION

In a first aspect, the present invention is directed to a continuous in-line process for making a fragrance composition, comprising the steps of:
(a) providing into a main line a pre-filtration solvent and a pre-filtration non-polar ingredient to provide a pre-filtration solution;
(b) mixing the pre-filtration solution in upstream proximity to a filter to form a mixed solution containing precipitates streaming through the main line; and
(c) filtering the mixed solution to remove precipitates to provide a post-filtration solution streaming through the main line to make the fragrance composition.

In another aspect, a system for continuous in-line manufacturing process of a wide variety of fragrance compositions is provided which requires less capital with respect to mixing tanks, pumps and piping and eliminates the chilling step (i.e., no heat exchangers, and cooling utilities). The continuous in-line manufacturing process provides significant cost savings resulting from minimizing material loss/waste, and faster manufacturing, and/or energy savings by at least the elimination of the chilling step.

In yet another aspect of the present invention, a fragrance composition obtained by the continuous in-line process is provided and is equivalent to the fragrance composition produced by the batch manufacturing process, particularly with no or negligible consumer noticeable differences in olfactory profile and/or aesthetics. It is desirable that the continuous in-line process for the preparation of the fragrance composition does not develop turbidity or precipitates, particularly after product storage.

These and other features of the present invention will become apparent to one skilled in the art upon review of the following detailed description when taken in conjunction with the appended claims.

### BRIEF DESCRIPTION OF THE DRAWINGS

While the specification concludes with claims particularly pointing out and distinctly claiming the invention, it is believed that the invention will be better understood from the following description of the accompanying figures wherein:

FIG. 1 is a flow diagram of a batch making process for making fragrance composition of the prior art.

FIG. 2 is a flow diagram for a continuous in-line process for making fragrance composition according to an embodiment of the present invention.

### DETAILED DESCRIPTION OF THE INVENTION

### Definitions

As used in herein, the articles “a”, “an”, and the mean “one or more.”

As used herein, any of the terms “comprising”, “having”, “containing”, and “including” means that other parts, steps, etc. which do not adversely affect the end result can be added. Each of these terms encompasses the terms “consisting of” and “consisting essentially of”. Unless otherwise specifically stated, the elements and/or equipment herein are believed to be widely available from multiple suppliers and sources around the world.

As used herein, the term “continuous in-line process” means a process wherein all steps occur continuously, typically simultaneously once steady state is reached, without a waiting and/or holding time between steps.

As used herein, the term “fragrance composition” refers to a product composition intended for application to a body surface, such as for example, skin or hair, i.e., to impart a desirable odor thereto, or cover a malodor thereof. These product compositions are generally in the form of perfume concentrates, perfumes, eau de parfums, eau de toilettes, aftershaves, colognes, body splashes, body sprays, or the like. Additional non-limiting examples of “fragrance composition” may also include facial or body powder, foundation, body/facial oil, mousse, creams (e.g., cold creams), waxes, sunscreens and blocks, bath and shower gels, hair shampoos, hair conditioners, skin lotions, lip balms, self-tanning compositions, masks and patches, underarm antiperspirants and deodorants, and the like. The term “fragrance composition” may include a raw material for subsequent incorporation into any consumer product. The term “fragrance composition” may also include a cosmetic composition, which comprises a fragrance material for the purposes of delivering a pleasant smell to drive consumer acceptance of the cosmetic composition.

As used herein, the terms “mixing” and “blending” interchangeably refer to combining and further achieving a relatively greater degree of homogeneity thereafter.

As used herein, the term “odor profile” is a result of the combination of the so-called top, middle and base notes, if present, of a fragrance composition. An odor profile is composed of 2 characteristics: ‘intensity’ and ‘character’. The ‘intensity’ relates to the perceived strength while ‘character’ refers to the odor impression or quality of the perfume (i.e., fruity, floral, woody, etc.).

As used herein, the words “preferred”, “preferably” and variants refer to embodiments of the invention that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

All percentages, parts and ratios are based upon the total weight of the fragrance composition, unless otherwise specified. All such weights as they pertain to listed ingredients are based on the active level and, therefore do not include carriers or by-products that may be included in commercially available materials. The components, including those which may optionally be added, as well as methods for preparation, and methods for use, are described in detail below.

All ratios are weight ratios unless specifically stated otherwise. All temperatures are in Celsius degrees (° C.), unless specifically stated otherwise. All measurements referred to herein are made at about 25° C., i.e., room temperature conditions, unless otherwise specified. All dimensions and values disclosed herein (e.g., quantities, percentages, portions, and proportions) are not to be understood as being strictly limited to the exact numerical values recited. Instead, unless otherwise specified, each such dimension or value is intended to mean both the recited value and a functionally equivalent range surrounding that value. For example, a dimension disclosed as “40 mm” is intended to mean “about 40 mm.”

### Continuous In-Line Process

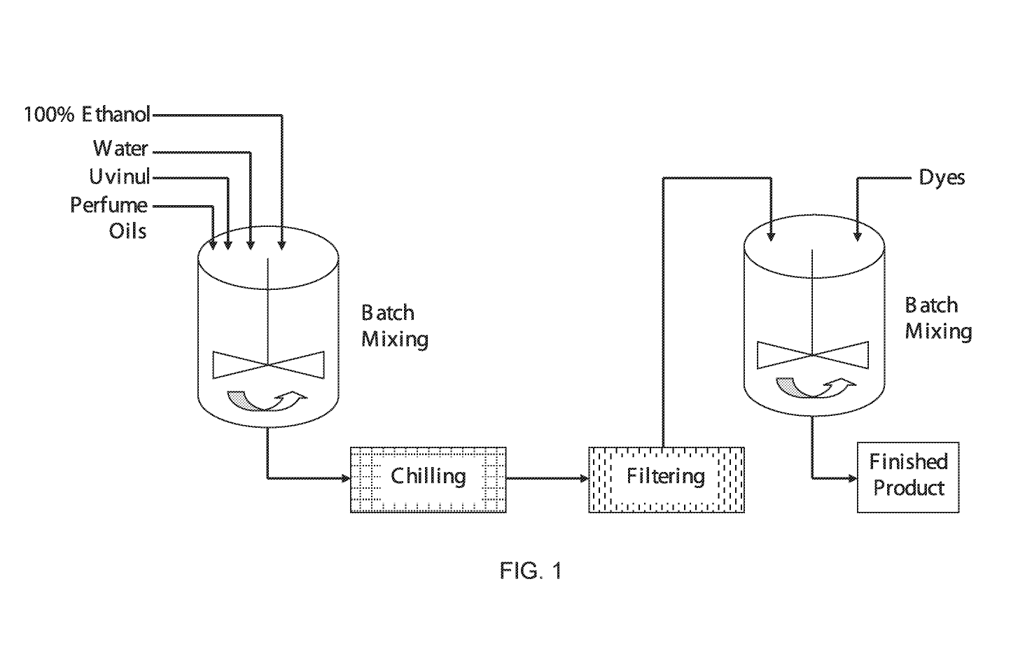

An illustrative flow diagram for the classic batch making process of the prior art for making fragrance composition is depicted in FIG. 1. As can be seen, the traditional batch making process for making fragrance compositions suffers from many disadvantages, in particular, lengthy production time, significant ingredient(s)/finished product waste, and/or excess inventories resulting in expensive storage costs. Furthermore, manufacturing a large variety of fragrance compositions increases the number of changeovers at the production sites. High changeover leads to increases in the amount of water used cleaning out mixing tanks, pipes and other equipment, and the amount of ingredients and component materials such as perfume oils washed down the drain. The current batch making process for manufacturing fragrance compositions also requires a chilling step to allow for formation of the waxy precipitates from the non-polar ingredients (e.g., perfume oils). This chilling step requires expensive cooling utilities to reduce the reaction temperature from ambient temperature to about 0° C. In today's environment of diminishing resources, these conditions pose sustainability challenges, and therefore a new manufacturing process is needed.

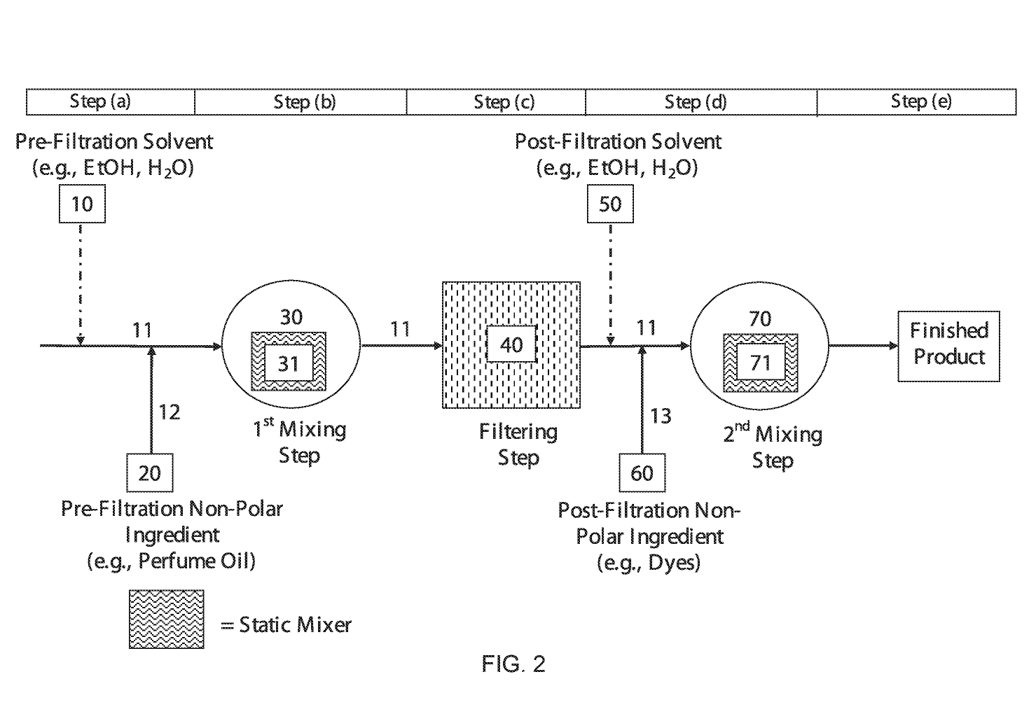

Accordingly, the continuous in-line process of the present invention can significantly reduce and/or eliminate the disadvantages described above. FIG. 2 depicts an embodiment of the continuous in-line process of the present invention. With reference to FIG. 2, the present invention changes fragrance composition making from a batch making process to a continuous in-line process, i.e., comprising multiple ingredient streams. Specifically, the present invention addresses manufacturing flexibility issues involved in making fragrance compositions to demand without compromising fragrance composition quality in terms of odor profile and/or visual appearance. The present continuous in-line process also provides faster variant (i.e., formulation changes) turnaround times, shorter clean-up times between variants, and/or significant material waste reduction than those of the classic batch making process. In one embodiment, the present continuous in-line process eliminates the chilling step, allowing for processing at room temperature, providing tremendous cost and/or time savings. Moreover, the present invention allows a high degree of fragrance composition customization, minimizing the need of dedicated storage vessels for different finished products which otherwise would need to be stored before the packing operation.

The foregoing benefits are possible, in part, due to the reduction and/or elimination of the lengthy residence time and/or the chilling step typically needed in the classic batch making process for mixing and chilling the solution to form the precipitated waxes, which tends to take up the majority of the batch cycle time. However, the reduction and/or elimination of the residence time from the continuous in-line process will have the undesirable consequence of limiting and/or preventing the necessary precipitation of the waxes out of solution. Surprisingly, the applicants have discovered that the precipitation reaction can be accelerated by a chemical solubility mechanism. In particular, it is possible to accelerate the precipitation reaction by splitting up the solvent. For example, instead of adding one hundred percent of the solvent (relative to the final fragrance composition) before a filtering step, the total amount of the solvent, with respect to the final fragrance composition, are divided so as to be added at least two different locations during the continuous in-line process for making the fragrance composition, such as, pre- and post- the filtering step (40) (i.e., pre-filtration solvent and post-filtration solvent). Alternatively, the total amount of the solvent, with respect to the final fragrance composition, can be divided so that it can be added at three, four, five or more locations for the continuous in-line process for making the fragrance composition, either pre- or post- the filtering step (40) as well. The amounts of the solvent to be added at the different locations may be the same or different, preferably the amounts of the solvent are different.

In an embodiment, the fragrance composition comprises from about 50 wt % to about 99 wt % or from about 75 wt % to about 95 wt % by weight of the total fragrance composition of the solvent.

In one aspect, the solvent is added at different points or locations in the continuous in-line process for making a fragrance composition. For example, “pre-filtration solvent” means any solvent that is provided before the filtration step of the continuous in-line process herein. There could be one or more pre-filtration solvents that are provided into the main line (e.g., a first pre-filtration solvent, a second pre-filtration solvent, etc.). In those embodiments where more than one pre-filtration solvent is used, these solvents may or may not be the same composition. As used herein, the term “post-filtration solvent” means any solvent that is provided after the filtration step of the continuous in-line process herein (even if additional filtration steps are employed downstream of the initial filtration step). There could be one or more post-filtration solvents that are provided into the main line (e.g., a first post-filtration solvent, a second post-filtration solvent, etc.). In those embodiments where more than one post-filtration solvent is used, these solvents may or may not be the same composition, and may or may not be the same composition relative to pre-filtration solvent(s).

Suitable examples of solvent include water and organic solvents such as a low molecular weight alcohol, more preferably C₁-C₅ alcohol, such as methanol and ethanol, preferably ethanol. Examples of suitable ethanol include: denatured ethanol from a fermented or distillation process from commercially available suppliers ALCODIS (Brussels, BE), Bundesmonopolverwaltung (Offenbach DE), France Alcools (Paris FR), Ineos Europe Ltd. (Grangemouth, UK), SDA BRABANT (Saint Benoite—FR), either from natural feed stocks (i.e., sugars, starch, or cellulose) or synthetic feed stocks.

In an embodiment, the solvent is ethanol, more preferably the ethanol may be a denatured or a diluted mixture of ethanol and water, which may include denaturants. In an embodiment, the final fragrance composition herein comprises from about 47 wt % to about 78 wt % by weight of the total fragrance composition of ethanol, and most preferably from about 47 wt % to about 73 wt %.

In an embodiment, the pre-filtration solvent comprises ethanol present in an amount of from about 30 wt % to about 48 wt %, whereby the wt % is relative to the total weight of the total fragrance composition. In an embodiment, the amount of the second ethanol component is from about 19 wt % to about 31 wt %, whereby the wt % is relative to the total weight of the fragrance composition.

In an embodiment, the % of the total ethanol attributable to the pre-filtration solvent (i.e., added in the step (a)) versus the post-filtration solvent (i.e., added in the step (d)) is from about 60:40 to about 40:60, or preferably between 60:40 to 50:50, or more preferably at a ratio of about 60:40. Advantages of the ratio addition of the ethanol is the accelerated wax precipitation, with benefit in terms of reduce product/processing time required and less amounts of waste generated for the continuous in-line process of the present invention.

While the above discussion is based on ethanol solvent for purposes of illustration only, it is intended that this approach can be applied by one skilled in the art to other organic solvents, preferably to those solvents having a polarity less than water but nevertheless soluble in water.

While not wishing to be bound by theory, it is believed that when the solvent system comprises an organic solvent and water, by lowering the levels of the organic solvent added prior to the filtering step (40), the water concentration is thereby increased to give a reduction in the amount of the organic solvent to water. Waxes tend to be more chemically insoluble in water versus ethanol given water's lower polarity. As a result, the reduction of ethanol solvent levels during the pre-filtering step results in acceleration of the wax precipitation out of solution. The balance of the ethanol solvents can then be added post the filtering step (40) to complete the recipe.

FIG. 2 depicts a flow diagram illustrating an embodiment of the steps of the continuous in-line process of the present invention. With reference to FIG. 2, in one aspect, the present continuous in-line process includes a liquid injection system which provides into a main line (11) a pre-filtration solvent (10) and a pre-filtration non-polar ingredient (20), preferably in liquid form, to provide a pre-filtration solution in the main line (11). In an embodiment, the pre-filtration solvent (10) is injected into the main line (11) at a rate of from about 0.9 L/min to about 20 L/min, preferably from about 16 L/min to about 18 L/min, more preferably 17.6 L/min. The liquid injection system allows for addition at the same time or sequential addition of these ingredients into the main line (11) to produce a pre-filtration solution in the main line (11). In an embodiment, the continuous in-line process of the present invention is free of any chilling or refrigeration step. Preferably, the resultant pre-filtration solution is maintained at a processing temperature of from about 10° C. to about 25° C., or preferably from about 17° C. to about 21° C. Preferably, the temperature of the continuous in-line process is never below 10° C.

In an embodiment, the pre-filtration solvent (10) comprises one or more organic solvents including alcohols, preferably low molecular weight alcohols, preferably C₁ to C₁₀ alcohols, more preferably C₁ to C₅ alcohols, even more preferably methanol and ethanol, and most preferably ethanol. Of this embodiment, the pre-filtration solvent (10) may further comprise water. The water may be provided before the alcohols into the main line (11) or the alcohols may be provided before the water into the main line (11) or the water and alcohols may be added into the main line (11) at the same time. Alternatively, the water and alcohols may be provided as a pre-mixture as the pre-filtration solvent (10) into the main line (11). The pre-mixture is formed by separately combining the water and alcohols. The benefit of adding the water and alcohols as a pre-mixture (to form a pre-filtration solvent (10)) is for the microbial preservation of the injection, which requires greater than 30% ethanol content by weight of the pre-mixture in the water to eliminate the need for a separate water treatment loop for sanitization. The pre-mixture can be subsequently mixed with the rest of the ingredients.

With continued reference to FIG. 2, step (a) provides into a main line (11) a pre-filtration non-polar ingredient (20) (e.g., perfume oil). Although a single perfume oil is illustrated in FIG. 2, the process may have multiple perfume oils each contained in its own respective perfume oil holding tank, wherein each of said perfume tanks (20) may hold its own fragrance composition and have its own respective perfume line (12) in fluid communication with the main line (11); or multiple perfume tanks (20) each sharing a single perfume line (12) in fluid communication to the main line (11); or combinations thereof. Alternatively, the fragrance composition holding tank is in fluid communication to a plurality of perfume raw material containers (not shown) holding perfume raw materials that can be metered individually into the fragrance composition tank to provide a unique or customizable fragrance compositions (held in the perfume holding tank (20)).

Optionally, one or more adjunct materials, although not shown in FIG. 2, are contained in one or more adjunct holding tanks containing one or more respective adjunct materials. These adjunct ingredients are provided into the main line (11) by: (i) one or more respective adjunct material lines that are in fluid communication from the adjunct material holding tank(s) to the main line (11); or (ii) wherein the adjunct material line is in fluid communication with the perfume line (12) (and thus added to the main line via the perfume line (12)); or (iii) the one or more adjunct lines are in fluid communication with the perfume holding tank (20) and wherein the adjunct(s) are added to the main line via the perfume holding tank (20) and respective perfume line (12); or (iv) combinations thereof.

In a preferred embodiment, the adjunct materials are provided into the main line (11) after step (a) where the pre-filtration solvent (10) and pre-filtration non-polar ingredient (20) have been provided into the main line (11) but before the first (1^{st}) mixing step (b). Although optional, in a preferred embodiment, the adjunct materials are provided into the main line (11) through a side line. Preferably, the adjunct material is provided into the main line (11) in liquid form. In one embodiment, the adjunct material(s) are selected from the group consisting of: (a) an oil-based pre-mixture, (b) a non-oil based pre-mixture, and (c) mixtures thereof. The oil-based pre-mixture, in turn, is selected from one or more ingredients consisting of a UV stabilizer, a skin active, a solubilizer, and combinations thereof. The non-oil based pre-mixture, in turn, is selected from one or more ingredients consisting of a chelating agent, a skin conditioning agent, a cyclodextrin, a pH buffering system, a perfume longevity agent, and combinations thereof.

The continuous in-line process comprises a further step (b) of mixing (30) (i.e., the first mixing step) the pre-filtration solution, and adjunct materials if present, in a mixer (31), in upstream proximity to a filter to form a mixed solution containing precipitates streaming through the main line (11). The mixer (31) is maintained at a mixing energy sufficient to produce a mixed solution of uniform dispersion and allow for the precipitation of the waxes from the perfume oils. The residence time for the first mixing step (b) for the continuous in-line process versus the batch making process is greatly reduced or even eliminated. For example, suitable residence time for the first mixing step (b) for the continuous in-line process is from about 0 min to about 10 mins, preferably from about 0.1 sec to about 2 mins or more preferably eliminated or negligible (i.e., 0 min).

The mixed solution then undergoes step (c), which is a filtering step (40) (i.e., first mixing step) to remove the undesirable precipitates (e.g., wax precipitates) formed during the first mixing step (b). The filtering step (c) (40) is accomplished by streaming the mixed solution through a filter to provide a post-filtration solution. Non-limiting examples of suitable filters include a lenticular filter or a cartridge filter having a pore size having an average diameter of from about 1 μm to about 10 μm, preferably between about 1 μm to about 3 μm, or more preferably between about 2 μm to about 3 μm. An example of a suitable cartridge filter is one commercially available from PALL Profile Star polypropylene Filter, 3.0 μm KA3A030P1, or Carlson Lenticular cellulose Filters, ID XE50H, LC 1216G.

In an embodiment, after the filtering step (c), the continuous in-line process may comprise the further step (d) (50) of providing into the main line (11) a post-filtration solvent to the filtered solution to provide a post-filtration solution, and the further step (e) (70) (i.e., the second mixing step) of mixing the post-filtration solution to make the fragrance composition. As before, the mixer (71) is maintained at a mixing energy sufficient to produce a final fragrance composition having uniform dispersion of all of the ingredients. Suitable residence time for the 2^{nd} mixing step for the continuous in-line process is from about 0 min to about 10 mins, preferably from about 0.1 sec to about 2 mins, or more preferably eliminated or negligible (i.e., 0 min).

In an embodiment, the mixers (31, 71) are static mixers. An example of a suitable static mixer is one commercially available from Lotus Mixers, Inc. (Nokomis Fla.) under the product name “SL static mixer”, or from Sulzer Ltd., under the product name “Static Mixer Type SMX”.

In an embodiment, the continuous in-line process may comprise a further step of providing into the main line (11) a post-filtration non-polar ingredient (60) to the post-filtration solution, preferably the further step is following step (d) (50). Non-limiting examples of a suitable post-filtration non-polar ingredient (60) includes a dye solution for aesthetic purposes, wherein the dye solution is selected from the group consisting of: dyes, colorants, speckles and mixtures thereof.

Other aspect of the present invention provides for a continuous in-line process of making a fragrance composition comprising the steps of:
(a) providing into a main line a pre-filtration solvent (10) and a pre-filtration non-polar ingredient (20) to provide a pre-filtration solution,
   wherein the pre-filtration solvent comprises:
   (i) from about 30 wt % to about 48 wt %, relative to the total weight of the fragrance composition, of ethanol; and
   (ii) from about 2 wt % to about 44 wt %, relative to the total weight of the fragrance composition, of water;
   wherein the pre-filtration non-polar ingredient (20) comprises from about 0.1 wt % to about 40 wt %, relative to the total weight of the fragrance composition, of a perfume oil;
(b) mixing the pre-filtration solution in upstream proximity to a filter to form a mixed solution containing precipitates streaming through the main line;
(c) filtering the mixed solution using the filter having a pore size having an average diameter of from about 1 μm to about 10 μm to provide a filtered solution streaming through the main line;
(d) providing into the main line a post-filtration solvent (50) to the filtered solution to provide a post-filtration solution, wherein the post-filtration solvent (50) comprises from about 19 wt % to about 30 wt %, relative to the total weight of the fragrance composition, of ethanol;
(e) optionally, providing into the main line a post-filtration non-polar ingredient (60) to the post-filtration solution, wherein the post-filtration non-polar ingredient (60) comprises a dye; and
(f) mixing the post-filtration solution to make the fragrance composition.

In an embodiment, acceptable amounts of finished product or intermediate fragrance compositions can be re-mixed in the continuous in-line process. This allows for a reduction and/or elimination of costs linked to disposal and/or scrap of these liquid compositions, which are obtained by planned or unplanned manufacturing operations. For example, products which could either not have been shipped to the market according to internal manufacturing guidelines or returned from the trade after having been previously shipped.

### Perfume Oils

In an embodiment of the present invention, the pre-filtration non-polar ingredient (20) is preferably “perfume oils” and which relates to a perfume raw material, or a mixture of perfume raw materials, that are used to impart an overall pleasant odor or fragrance profile to a composition. Perfume oils can encompass any suitable perfume raw materials for fragrance uses, including materials such as, for example, alcohols, aldehydes, ketones, esters, ethers, acetates, nitriles, terpene hydrocarbons, nitrogenous or sulfurous heterocyclic compounds and essential oils. However, naturally occurring plant and animal oils and exudates comprising complex mixtures of various chemical components are also know for use as “fragrance materials”. The individual perfume raw materials which comprise a known natural oil can be found by reference to Journals commonly used by those skilled in the art such as “Perfume and Flavourist” or “Journal of Essential Oil Research”, or listed in reference texts such as the book by S. Arctander, Perfume and Flavor Chemicals, 1969, Montclair, N.J., USA and more recently re-published by Allured Publishing Corporation Illinois (1994).

Additionally, some perfume raw materials are supplied by the fragrance houses (Firmenich, International Flavors & Fragrances (“IFF”), Givaudan, Symrise) as mixtures in the form of proprietary specialty accords. Non-limiting examples of the fragrance materials useful herein include pro-fragrances such as acetal pro-fragrances, ketal pro-fragrances, ester pro-fragrances, hydrolyzable inorganic-organic pro-fragrances, and mixtures thereof. The fragrance materials may be released from the pro-fragrances in a number of ways. For example, the fragrance may be released as a result of simple hydrolysis, or by a shift in an equilibrium reaction, or by a pH-change, or by enzymatic release.

Preferably, the fragrance composition herein comprises from about 0.1 wt % to about 40 wt % by weight of the total fragrance composition of a perfume oil or a mixture thereof, more preferably from about 2.5 wt % to about 25 wt %, and most preferably from about 2.5 wt % to about 20 wt %.

### Adjunct Materials

In an embodiment of the present invention, optionally one or more adjunct materials can be added to step (a), wherein the adjunct materials are selected from the group consisting of: (a) an oil-based pre-mixture, (b) a non-oil based pre-mixture and (c) mixtures thereof.

The oil-based pre-mixture is selected from one or more ingredients consisting of a UV stabilizer, a skin active, a solubilizer, and combinations thereof.

The non-oil based pre-mixture is selected from one or more ingredients consisting of a chelating agent, a skin conditioning agent, cyclodextrin, a pH buffering system, a perfume longevity agent, and combinations thereof. Preferably, the fragrance composition herein comprises from about 3 wt % to about 17 wt % by weight of the total fragrance composition of a non-oil pre-mixture.

(A) UV Stabilizers:

Examples of suitable UV stabilizers include:

(i) Cinnamic derivatives: ethylhexyl methoxycinnamate (e.g., “Parsol® MCX” from DSM Nutritional Products, Inc.), isopropyl methoxycinnamate, isoamyl p-methoxycinnamate (e.g., “Neo Heliopan® E 1000” from Symrise), DEA methoxycinnamate, diisopropyl methylcinnamate, and glyceryl ethylhexanoate dimethoxycinnamate.

(ii) Dibenzoylmethane derivatives: butyl methoxydibenzoylmethane (e.g., “Parsol® 1789” from DSM Nutritional Products, Inc.) and isopropyl dibenzoylmethane.

(iii) Para-aminobenzoic acid derivatives: PABA, ethyl PABA, ethyl dihydroxypropyl PABA, ethylhexyl dimethyl PABA (e.g., “Escalol® 507” from ISP), glyceryl PABA, PEG-25 PABA (e.g., “Uvinul® P25” from BASF).

(iv) Salicylic derivatives: homosalate (e.g., “Eusolex® HMS” from Merck KGaA/EMD Chemicals, Inc. and EMD Chemicals Inc.), ethylhexyl salicylate (e.g., “Neo Heliopan® OS” from Symrise), dipropylene glycol salicylate (e.g., “Dipsal” from Lubrizol Advanced Materials, Inc.), TEA salicylate (e.g., “Neo Heliopan® TS” from Symrise).

(v) Diphenylacrylate derivatives: octocrylene (e.g., “Uvinul® N539T” from BASF), etocrylene (e.g., “Uvinul® N35” from BASF).

(vi) Benzophenone derivatives: benzophenone-1 (e.g., “Uvinul® 400” from BASF), benzophenone-2 (e.g., “Uvinul® D50” by BASF, benzophenone-3 or oxybenzone (e.g., “Uvinul® M40” from BASF), benzophenone-4 (e.g., “Uvinul® MS40” from BASF), benzophenone-5, benzophenone-6 marketed (e.g., “Helisorb™ 11” from Norquay), benzophenone-8, benzophenone-9, benzophenone-1 2, nhexyl 2-(4-diethylamino-2-hydroxybenzoyl)benzoate (e.g., “Uvinul® A+” from BASF).

(vii) Benzylidenecamphor derivatives: 3-benzylidenecamphor (e.g., “Mexoryl® SD” from Chimex), 4-methylbenzylidenecamphor (e.g., “Eusolex® 6300” by Merck), benzylidene camphor sulfonic acid (e.g., “Mexoryl® SL” from Chimex), camphor benzalkonium methosulfate (e.g., “Mexoryl® SO” from Chimex), terephthalylidene dicamphor sulfonic acid (e.g., “Mexoryl® SX” from Chimex), polyacrylamidomethyl benzylidene camphor (e.g., “Mexoryl® SW” from Chimex).

(viii) Phenylbenzimidazole derivatives: phenylbenzimidazole sulfonic acid (e.g., “Eusolex® 232” from Merck and EMD INC.), disodium phenyl dibenzimidazole tetrasulfonate (e.g., “Neo Heliopan® AP” from Symrise).

(ix) Phenylbenzotriazole derivatives: drometrizole trisiloxane, methylene bis(benzotriazolyl) tetramethylbutylphenol, or in micronized form as an aqueous dispersion (e.g., “Tinosorb® M” from BASF).

(x) Triazine derivatives: bis-ethylhexyloxyphenol methoxyphenyl triazine (e.g., “Tinosorb® S” from BASF), ethylhexyl triazone (e.g., “Uvinul T 150” from BASF), diethylhexyl butamido triazone (e.g., “Uvasorb® HEW from 3V Group), 2,4,6-tris(dineopentyl 4′-aminobenzalmalonate)-s-triazine, 2,4,6-tris(diisobutyl 4′-aminobenzalmalonate)-striazine, 2,4-bis(n-butyl 4′-aminobenzoate)-6-(aminopropyltri-siloxane)-s-triazine, 2,4-bis(dineopentyl 4′-aminobenzalmalonate)-6-(n-butyl 4′-amino-benzoate)-s-triazine, triazine agents, especially 2,4,6-tris(biphenyl-1,3,5-triazines (in particular 2,4,6-tris(biphenyl-4-yl)-1,3,5-triazine and 2,4,6-tris(terphenyl)-1,3,5-triazine.

(xi) Anthranilic derivatives: menthyl anthranilate (e.g., “Neo Heliopan® MA” from Symrise).

(xii) Imidazoline derivatives: ethylhexyl dimethoxybenzylidene dioxoimidazoline propionate.

(xiii) Benzalmalonate derivatives: polyorganosiloxane containing benzalmalonate functions, for instance polysilicone-15, (e.g., “Parsol® SLX” from DSM Nutritional Products, Inc.)

(xiv) 4,4-diarylbutadiene derivatives: 1,1-dicarboxy(2,2′-dimethylpropyl)-4,4-diphenylbutadiene.

(xv) Benzoxazole derivatives: 2,4-bis[5-(1-dimethylpropyl)benzoxazol-2-yl(4-phenyl)imino]-6-(2-et-hylhexyl)imino-1,3,5-triazine (e.g., “Uvasorb® K 2A” from Sigma 3V), and mixtures thereof.

Optional organic UV stabilizers may be chosen from among: ethylhexyl methoxycinnamate, ethylhexyl salicylate, homosalate, butyl methoxydibenzoylmethane, octocrylene, phenylbenzimidazole sulfonic acid, benzophenone-3, benzophenone-4, benzophenone-5, n-hexyl 2-(4-diethylamino-2-hydroxybenzoyl)benzoate, 4-methylbenzylidene camphor, terephthalylidene dicamphor sulfonic acid, disodium phenyl dibenzimidazole tetrasulfonate, methylene bisbenzotriazolyl tetramethylbutylphenol, bis-ethylhexyloxyphenol methoxyphenyl triazine, ethylhexyl triazone, diethylhexyl butamido triazone, 2,4,6-tris(dineopentyl 4′-aminobenzalmalonate)-s-triazine, 2,4,6-tris(diisobutyl 4′-aminobenzalmalonate)-striazine, 2,4-bis(n-butyl 4′-aminobenzoate)-6-(aminopropyltrisiloxane)-s-triazine, 2,4-bis(dineopentyl 4′-aminobenzalmalonate)-6-(n-butyl 4′-aminobenzoate)-s-triazine, 2,4,6-tris(biphenyl-4-yl)-1,3,5-triazine, 2,4,6-tris(terphenyl)-1,3,5-triazine, or drometrizole.

Preferably, the fragrance composition herein comprises from 0 wt % to about 3 wt % by weight of the total fragrance composition of a UV stabilizer or a mixture thereof, more preferably from 0.30 wt % to 1.60 wt %, and most preferably from 0.30 wt % to 0.60 wt %.

(B) Skin Actives:

Examples of suitable skin actives include:

(i) PEG-40 Hydrogenated Castor Oil: polyethylene glycol derivative of Hydrogenated Castor Oil (e.g., “Cremophor CO 410” from BASF).

(ii) PEG-6 Caprylic/Capric Glycerides: a polyethylene glycol derivative of a mixture of mono-, di-, and triglycerides of caprylic and capric acids (e.g., “Glycerox767HC” from Croda Chemicals Europe Ltd or “Softigen 767” from Cremer OLEO GmbH).

Preferably, the fragrance composition herein comprises from 0 wt % to about 3 wt % by weight of the total fragrance composition of a skin active or a mixture thereof.

(C) Solubilizers:

Examples of suitable solubilizers include:

(i) Polyethylene glycol derivatives of castor oils or hydrogenated castor oils (e.g. PEG-40 Hydrogenated Castor Oil); and

(ii) Caprylic/Capric Glycerides (e.g. PEG-6).

Preferably, the fragrance composition herein comprises from 0.10 wt % to 1.20 wt % by weight of the total fragrance composition of a solubilizer or a mixture thereof.

(D) Chelating Agents:

Example of a suitable chelating agent is Disodium EDTA (e.g., “Dissolvine Na2-S” from BASF).

Preferably, the fragrance composition herein comprises from 0 wt % to 0.001 wt % by weight of the total fragrance composition of a chelating agent or a mixture thereof.

(E) Skin Conditioning Agents:

Examples of suitable skin condition agents include:

(i) Carboxylic Acids (Lactic Acid, e.g., “Purac PF90” from Purac Biochem BV or “Lactic Acid 90%” from Merck); terpenes and 3-Cyclohexene-1-Methanol, α,4-Dimethyl-α-(4-Methyl-3-Pentenyl)- (e.g., “Dragosantol 100” from Symrise GmbH);

(ii) Anti-Acne Skin Active Agents: heterocyclic organic compound that conforms to the formula (2,5-Dioxo-4-Imidazolidinyl)Urea (e.g., “Allantoin” from Clariant Corp.); and (iii) Deodorants: Ethylhexylglycerin, Octoxyglycerin, 1,2-Propanediol, 3-((2-Ethylhexyl)Oxy)- (e.g., “Sensiva SC 50” from Schuelke & Mayr Gmbh).

Preferably, the fragrance composition herein comprises from 0 wt % to about 3 wt % by weight of the total fragrance composition of a skin conditioning agent or a mixture thereof.

(F) Cyclodextrin:

Example of a suitable cyclodextrin includes: (Methyl-beta cyclodextrin) (e.g., “Cavasol W7 M TL ETOH” from Wacker Chemie GmbH).

Preferably, the fragrance composition herein comprises from 3.25 wt % to about 20 wt % by weight of the total fragrance composition of a cyclodextrin or a mixture thereof.

(G) pH Buffering System:

Example of a suitable buffering system includes: inorganic bases (e.g., Sodium Hydroxide) and organic acids (e.g., Citric Acid).

Preferably, the fragrance composition herein comprises from 0 wt % to 0.24 wt % by weight of the total fragrance composition of a pH buffering system.

(H) Perfume Longevity Agent:

Example of a suitable perfume longevity agent includes:

(i) Carbohydrates: monosaccharides, disaccharides, polysaccharides, glycosaminoglycans and derivatives (e.g., “Cavasol W7 M TL ETOH” from Wacker Chemie GmbH).

(ii) Alkoxylated methyl glucoside selected from the group consisting of methyl glucoside polyol, ethyl glucoside polyol, and propyl glucoside polyol, preferably PPG-20 Methyl Glucose Ether (see WO2014/093807, Cetti et al.)

(iii) Isocetyl alcohol (e.g., CERAPHYL® ICA), PPG-3 myristyl ether (e.g., Tegosoft™ APM and/or Varonic® APM), Neopentyl glycol diethylhexanoate (e.g., Schercemol™ NGDO) and mixtures thereof.

Preferably, the fragrance composition herein comprises from 3.25 wt % to about 20 wt % by weight of the total fragrance composition of a perfume longevity agent or a mixture thereof.

### Fragrance Composition

Non-limiting examples of fragrance composition resulting from the continuous in-line process according to the present invention are selected from the group consisting of a perfume, an eau de toilette, an eau de parfum, a cologne, a body splash or a body spray.

### Test Methods

The following assays set forth must be used in order that the invention described and claimed herein may be more fully understood.

### Test Method 1: Turbidity Test

Precipitation of the waxy carry-overs from the reaction between the ethanol/water solvent system and the perfume oils during the continuous in-line process and classic batch making process (including intermediate and finished products) can be measured on the basis of turbidity using a Kemtrak TC007 Industrial Turbidimeter (Sweden). Turbidity of the fragrance composition is measured (in mg/L) at 25° C. between 0.01 NTU (Number of Turbid Units) to 10.0 NTU and according to the conditions as set out in Table 1 herein below. Samples are measured in-line during making for 30 seconds and the measurements for each sample are recorded and averaged.

TABLE 1
Turbidity Measurement Conditions

| | | | Time After |
|---|---|---|---|
| No. | Process Type | Measurement Point | Production |
| 1 | Continuous in-line | In the main line (11) after | 0 |
| | Process | the mixing step (b). | |
| 2 | Continuous in-line | In the main line (11) after | 0 |
| | Process | the filtering step (c). | |
| 3 | Continuous in-line | Off-line of the finished | Immediately |
| | Process | product after the second | after |
| | | ethanol addition in step (d). | production |
| 4 | Batch Making Process | After the chilling step. | 0 |
| 5 | Batch Making Process | After the filtering step. | Immediately |
| | | | after |
| | | | production |

The turbidity measurements from the continuous in-line process versus the batch manufacturing process are compared to check for any notable differences in level of the formation of the wax precipitations.

### Test Method 2: Odor Profile Evaluation

In order to assess the odor profile of the fragrance composition, test fragrance compositions, as described in the Example section, are given to panelists to evaluate. Panelists are selected from individuals who are either trained to evaluate odor profile according to the scales below or who have experience of fragrance evaluation in the industry.

Odor profile for each test fragrance composition is evaluated immediately after production or after a storage period of anywhere between 1 to 3 months at varying temperatures of 5° C., 25° C. and 40° C. Evaluation is performed by the panelists using smelling strips (i.e., thin paper blotters). The paper blotter is immersed approximately 2 cm into the test fragrance composition. The panelists are then asked to evaluate the odor profile at two characteristic time points for each sample:

(i) Top Note: Odor profile evaluated within 5 minutes after immersing the paper blotter into the fragrance composition.

(ii) Dry Down: Odor profile evaluated after the volatile components have evaporated (i.e., base notes of the fragrance). Typically, this is evaluated at about 1-2 hours after the blotter has been dipped into the fragrance composition and allowed to air dry at room temperature.

For each time point, the panelists are asked to give a score of 1 to 5 for odor profile according to the odor score scale set out in Table 2 herein below. The odor performance is evaluated on a 5-point scale versus an odor standard (i.e., comparable fragrance compositions made with the batch process). Evaluation criteria are as follows:

(i) Evaluation scores of 1, 2 and 3 pass odor evaluation versus the standard.

(ii) Evaluation scores of 4 and 5 do not pass odor evaluation versus standard.

TABLE 2
Odor Evaluation Scale for Fragrance Compositions

| Odor Score | Evaluation Description |
|---|---|
| 1 | Perfume unchanged - no difference versus standard |
| 1a | Perfume weaker but character unchanged |
| 1b | Perfume stronger but character unchanged |
| 2 | Slight change - only noticeable when compared directly |
| | with standard; consumer acceptable |
| 3 | Noticeable change but of similar character to standard; |
| | consumer acceptable |
| 4 | Large difference in perfume character; consumer noticeable |
| | (i.e., unacceptable versus standard) |
| 5 | Total difference in perfume character (i.e., unacceptable |
| | versus standard) |

### EXAMPLES

The following examples are provided to further illustrate the present invention and are not to be construed as limitations of the present invention, as many variations of the present invention are possible without departing from its spirit or scope.

### Example 1

### Fragrance Compositions

Compositions A to E are non-limiting examples of formulations of fragrance compositions of the present invention. The following fragrance compositions are made by mixing the listed ingredients, and adjunct materials if present, in the listed proportions (wt %) at room temperature, wherein the wt % is relative to the total weight of the fragrance composition. The following fragrance compositions are made by feeding ingredients, and adjunct materials if present, into a main stream (11), which is a pipe having a diameter of about 6 mm, and ingredients are added through a side stream, such as for example, a T-junction through a 3 mm pipe. The side stream can be equipped with a pump and a flow meter to ensure that the correct amounts of ingredients/materials are dosed into the main line (11).

In step (a), the ingredients (i.e., solvents, non-polar ingredients) are provided sequentially into the main line (11). For example, the pre-filtration solvent (e.g., ethanol, water) and pre-filtration non-polar ingredients (e.g., perfume oils) are provided into the main line through a side stream (12). The pre-filtration solvent (e.g., ethanol, water) are either pre-mixed and then added to the target fragrance composition or injected as separate streams into the main line (11) to form the pre-filtration solution. Optionally, in step (a), adjunct materials (e.g., Uvinul, non-oil based pre-mixture, etc.) are added into the main line (11). In step (b), the pre-filtration solution is mixed to form a mixed solution containing precipitates streaming through the main line (11). During the first mixing step (b), the pre-filtration solution and adjunct materials, if present, are mixed through a static mixer (31) in the main line (11) immediately after material injection (e.g., 6 mm diameter, SMX or Helical configuration, 10-12 elements in length). The mixed solution underwent zero residence time.

In filtering step (c), the mixed solution is filtered through a cartridge filter or a lenticular filter, having a pore size having an average diameter of from about 1 μm to about 10 μm to remove the wax precipitations. After the filtration step (c), a post-filtration solvent is added into the main line (11) to the filtered solution in step (d) via a first side stream and, optionally, a dye solution is added through a second side stream (13) into the main stream (11). The filtered solution is then mixed with a second static mixer (71) (e.g., 6 mm diameter, SMX or Helical configuration, 10-12 elements in length) to form the fragrance composition.

This is a continuous in-line process with continuous flow through a pipe with no intermediate process stops or breaks in the lines. The process is run at ambient processing temperatures, such as for example, between 10° C. to 25° C., and more preferably within 17° C. to 21° C. The continuous process results in a finished fragrance composition as set out in Table 3 herein below.

TABLE 3
Fragrance Compositions

| | Composition (wt %)¹ | | | | |
|---|---|---|---|---|---|
| Ingredient | A | B | C | D | E |
| Water | 2.27 | 9.65 | 3.40 | 42.95 | 22.74 |
| Ethanol | 77.43 | 78.00 | 75.0 | 50.00 | 69.11 |
| Perfume oil* | 20.0 | 10.0 | 10.0 | 3.00 | 7.00 |
| Uvinul^{‡} | 0.30 | 1.60 | 0.60 | 0.30 | 0.30 |
| Non-oil based | 0.0 | 0.0 | 10.0 | 3.75 | 0.85 |
| pre-mixture | | | | | |
| Dyes | 0.0 | 0.75 | 1.0 | 0.0 | 0.0 |
| Total | 100.00 | 100.00 | 100.00 | 100.00 | 100.00 |

*Supplied by Givaudan, IFF or Firmenich.
^{‡}Supplied by BASF.
¹Wt % is relative to the total weight of the fragrance composition.

### Example 2

### Turbidity Assessment

Fragrance compositions made by either the classic batch making process or the continuous in-line process are evaluated for wax precipitation in accordance with the protocol described in the Test Method section. Turbidity is evaluated at initial time 0 (immediately after production). A summary of the results are set out in Table 4 herein below.

TABLE 4
Turbidity Data

| | | Turbidity |
|---|---|---|
| | Turbidity from Batch | from Continuous in-line |
| Perfume | Process [NTU] | Process [NTU] |
| Boss Bottle | 0.345 | 0.370 |
| Night EdT | | |
| Hugo Boss | 0.300 | 0.390 |
| EdT | | |
| Lacoste EdT | 0.317 | 0.390 |
| D&G - The | 0.537 | 0.464 |
| One Man EdT | | |
| D&G - Light | 0.412 | 0.490 |
| Blue EdT | | |
| Boss - Hugo | 0.345 | 0.360 |
| Boss EdT | | |

The results show that the same fragrance composition, with respect to turbidity, is achieved with the continuous in-line process of manufacturing with the 2 ratioed additions of solvents at different locations in the process, such as for example: zero minutes residence time at ambient processing temperatures versus the batch making process with 15 to 90 mins residence time and chilling to 0° C. Overall, the results indicate:

(i) The same turbidity was achieved in the continuous in-line process and the batch making process for the pre-filtration, post-filtration, and in the finished product.

(ii) It is believed that by achieving the same turbidity pre-filtering in the continuous in-line process and the batch making process, the same level of wax precipitation and therefore composition of precipitation is achieved in the two processes.

(iii) The change in turbidity across the filter is the same between the two processes, showing the same amount of precipitation is removed by the filtering step in the two processes.

(iv) The same turbidity is found in the finished products made from the two processes. Both finished products have the same level of precipitation, and therefore are the same composition in the finished products.

### Example 3

### Odor Profile Assessment

To evaluate the odor profile for products made on the continuous in-line process versus the batch making process, fragrance compositions as disclosed in Table 4 are made. Products on the continuous in-line process are made according to the process as described in FIG. 2. Products made on the batch manufacturing system are made using the classic batch making process as described in FIG. 1. Products from the two processes are made with the same lots of raw materials and manufactured within 24 hours of each other. Products made on the batch manufacturing system are used as the odor standard for odor profile evaluations. The odor profile of products made on the continuous in-line process is evaluated against the batch manufactured products.

Products made by either the batch process or the continuous in-line process of the present invention are applied to paper blotters in accordance with the protocol described in the Test Method section. A panel of 4 or 5 panelists evaluated the odor profile at initial time 0 (i.e., fresh, as made product), then at various time points of 1 and 3 months post production after storage at 5° C. (i.e., reduced aging), 25° C. (i.e., ambient aging) and 40° C. (i.e., accelerated aging). At each aging time and temperature, the odor profile of the product made on the continuous in-line process is evaluated against the odor profile of the batch manufacturing process aged for the same time and condition according to the criteria as disclosed in the Test Method section. A summary of the results are set out in Table 5 herein below.

TABLE 5
Odor Profile Data

| | Initial Odor | | | | | Aged Odor | | | | | |
|---|---|---|---|---|---|---|---|---|---|---|---|
| | | | Hot | Hot | Hot | Odor Top Note vs. Aged | | | | | |
| | Top | Dry | Plate | Plate | Plate | Batch Standard | | | | | |
| Fragrance | Note | Down | 0 hr | 1 hr | 3 hrs | 1 month/ | 3 months/ | 1 month/ | 3 months/ | 1 month/ | 3 months/ |
| Composition | Initial | Initial | Initial | Initial | Initial | 5° C. | 5° C. | 25° C. | 25° C. | 40° C. | 40° C. |
| Boss Bottled | 2 | 3 | 2 | 2 | 3 | 2 | 2 | 2 | 2 | 2 | 2 |
| Night EdT | | | | | | | | | | | |
| Hugo Boss EdT | 2 | 2 | 3 | 3 | 2 | 3 | 2 | 2 | 2 | 2 | 2 |
| Lacoste EdT | 2 | 3 | 2 | 2 | 2 | 3 | 2 | 3 | 2 | 2 | 2 |
| D&G The One | 2 | 2 | 2 | 2 | 2 | 3 | 2 | 3 | 2 | 3 | 2 |
| Man EdT | | | | | | | | | | | |
| D&G Light Blue | 2 | 2 | 2 | 3 | 2 | 2 | 3 | 3 | 2 | 3 | 2 |
| EdT | | | | | | | | | | | |
| Boss EdT | 2 | 2 | 2 | 3 | 3 | 2 | 2 | 2 | 2 | 2 | 2 |

| | Aged Odor | | | | | |
|---|---|---|---|---|---|---|
| | Odor Dry Down vs. | | | | | |
| Fragrance | Aged Batch Standard | | | | | |
| Composition | 1 month/5° C. | 3 month/5° C. | 1 month/25° C. | 3 month/25° C. | 1 month/40° C. | 3 months/40° C. |
| Boss Bottled | 2 | 2 | 2 | 2 | 2 | 2 |
| Night EdT | | | | | | |
| Hugo Boss EdT | 2 | 2 | 2 | 2 | 2 | 3 |
| Lacoste EdT | 2 | 3 | 2 | 2 | 2 | 3 |
| D&G The One | 3 | 3 | 3 | 2 | 2 | 3 |
| Man EdT | | | | | | |
| D&G Light Blue | 3 | 2 | 2 | 2 | 2 | 2 |
| EdT | | | | | | |
| Boss EdT | 2 | 2 | 2 | 2 | 2 | 2 |

All average scores at initial evaluation and during aging out to 3 months show no consumer noticeable differences of the odor profile between products made by the continuous in-line process and the batch making process. All scores are >4 or 5.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A continuous in-line process for making a fragrance composition, comprising the steps of:
(a) providing into a main line a pre-filtration solvent and a pre-filtration non-polar ingredient to provide a pre-filtration solution;
(b) mixing the pre-filtration solution in upstream proximity to a filter to form a mixed solution containing precipitates streaming through the main line; and
(c) filtering the mixed solution to remove precipitates to provide a post-filtration solution streaming through the main line to make the fragrance composition.

2. The continuous in-line process according to claim 1, comprising further steps of:
(d) providing into the main line a post-filtration solvent to the filtered solution to provide a post-filtration solution; and
(e) mixing the post-filtration solution to make the fragrance composition.

3. The continuous in-line process according to claim 2, comprising a further step following step (d) of providing into the main line a post-filtration non-polar ingredient to the post-filtration solution.

4. The continuous in-line process according to claim 3, wherein the post-filtration non-polar ingredient is selected from the group consisting of dyes, colorants, speckles and mixtures thereof.

5. The continuous in-line process according to claim 2, wherein the pre-filtration solvent or the post-filtration solvent comprises an organic solvent.

6. The continuous in-line process according to claim 5, wherein the pre-filtration solvent and the post-filtration solvent comprise ethanol.

7. The continuous in-line process according to claim 6, wherein the % of the total ethanol attributable to the pre-filtration solvent versus the post-filtration solvent is from about 60:40 to about 40:60.

8. The continuous in-line process according to claim 1, wherein the pre-filtration non-polar ingredient comprises from about 0.1 wt % to about 40 wt % by weight of the total fragrance composition of a perfume oil or a mixture thereof

9. The continuous in-line process according to claim 1, wherein the pre-filtration solvent is provided into the main line at a rate of from about 0.9 L/min to about 20 L/min.

10. The continuous in-line process according to claim 1, wherein the filter has a pore size having an average diameter of from about 1 μm to about 10 μm.

11. The continuous in-line process according to claim 1, wherein the process is free of any chilling or refrigeration step.

12. The continuous in-line process according to claim 1, wherein the fragrance composition is free of any precipitates and comprises:
(i) from about 0.1 wt % to about 40 wt % of a perfume oil; and
(ii) from about 10 wt % to about 80 wt % of ethanol;
wherein the wt % is relative to the total weight of the fragrance composition.

13. The continuous in-line process according to claim 1, wherein residence time for the mixing step (b) is from about 0 min to about 10 mins.

14. A continuous in-line process of making a fragrance composition comprising the steps of:
(a) providing into a main line a pre-filtration solvent and a pre-filtration non-polar ingredient to provide a pre-filtration solution,
wherein the pre-filtration solvent comprises:
(i) from about 30 wt % to about 48 wt %, relative to the total weight of the fragrance composition, of ethanol; and
(ii) from about 2 wt % to about 44 wt %, relative to the total weight of the fragrance composition, of water;
wherein the pre-filtration non-polar ingredient comprises from about 0.1 wt % to about 40 wt %, relative to the total weight of the fragrance composition, of a perfume oil;
(b) mixing the pre-filtration solution in upstream proximity to a filter to form a mixed solution containing precipitates streaming through the main line;
(c) filtering the mixed solution using the filter having a pore size having an average diameter of from about 1 μm to about 10 μm to provide a filtered solution streaming through the main line;
(d) providing into the main line a post-filtration solvent to the filtered solution to provide a post-filtration solution, wherein the post-filtration solvent comprises from about 19 wt % to about 30 wt %, relative to the total weight of the fragrance composition, of ethanol;
(e) optionally, providing into the main line a post-filtration non-polar ingredient to the post-filtration solution, wherein the post-filtration non-polar ingredient comprises a dye; and
(f) mixing the post-filtration solution to make the fragrance composition.

15. A fragrance composition obtained by the continuous in-line process according to claim 1.
